(19) United States
(12) Patent Application Publication
(10) Pub. No.: US 2010/0068599 A1
(43) Pub. Date: Mar. 18, 2010

(54) FUEL CELL STACK

(75) Inventors: Koichiro FURUSAWA, Mooka-shi (JP); Kentaro NAGOSHI, Utsunomiya-shi (JP); Hideaki KIKUCHI, Utsunomiya-shi (JP); Shuichi TOGASAWA, Utsunomiya-shi (JP); Yasunori KOTANI, Utsunomiya-shi (JP)

Correspondence Address: LAHIVE & COCKFIELD, LLP;FLOOR 30, SUITE 3000, ONE POST OFFICE SQUARE, BOSTON, MA, 02109, US

(73) Assignee: Honda Motor Co., Ltd., Tokyo (JP)

(21) Appl. No.: 12/562,590

(22) Filed: Sep. 18, 2009

(30) Foreign Application Priority Data
Sep. 18, 2008 (JP) 2008-238800

(51) Int. Cl. H01M 2/00

(52) U.S. Cl. 429/34

(57) ABSTRACT

A fuel cell stack includes a stack body formed by stacking a plurality of power generation units. A first end power generation unit and first dummy units are provided near an end plate where reactant gas pipes for the stack body are provided. A second end power generation unit and second dummy units are provided near an end plate of the stack body on the opposite side. The number of first dummy units is larger than the number of second dummy units.

### CROSS-REFERENCE TO RELATED APPLICATION

This application is based upon and claims the benefit of priority from Patent Application No. 2008-238800 filed on Sep. 18, 2008, in the Japan Patent Office, of which the contents are incorporated herein by reference.

### BACKGROUND OF THE INVENTION

1. Field of the Invention

The present invention relates to a fuel cell stack including a stack body formed by stacking a plurality of power generation cells. Each of the power generation cells includes an electrolyte electrode assembly and a separator. The electrolyte electrode assembly includes a pair of electrodes and an electrolyte interposed between the pair of electrodes. Reactant gas flow fields are formed along electrode surfaces of the power generation cells. Reactant gas passages are connected to the reactant gas flow fields, and extend through the power generation cells in the stacking direction. Terminal plates, insulating plates, and end plates are provided at both ends of the stack body. Reactant gas pipes are connected to one of the end plates, and communicate with the reactant gas passages.

2. Description of the Related Art

For example, a solid polymer electrolyte fuel cell employs an electrolyte membrane that is a polymer ion exchange membrane. The electrolyte membrane is interposed between an anode and a cathode to form a membrane electrode assembly. The membrane electrode assembly and separators sandwiching the membrane electrode assembly make up a unit of power generation cell for generating electricity. In use, typically, a predetermined number of power generation cells are stacked together to form a fuel cell stack.

In the fuel cell, a fuel gas flow field (reactant gas flow field) for supplying a fuel gas to the anode is formed on a separator surface facing the anode, and an oxygen-containing gas flow field (reactant gas flow field) for supplying an oxygen-containing gas to the cathode is formed on a separator surface facing the cathode. Further, a coolant flow field for supplying a coolant along separator surfaces is formed between separators.

In some of the power generation cells of the fuel cell stack, in comparison with the other power generation cells, the temperature tends to be lowered easily due to heat radiation to the outside or the like. For example, in the power generation cells provided at ends in the stacking direction, considerable heat radiation occurs from components such as power collecting terminal plate (current collector plate) for collecting electricity generated by the power generation cells, and end plates provided for holding the stacked power generation cells. Therefore, the temperature is decreased significantly.

Due to the decrease in the temperature, in the power generation cells provided at the ends of the fuel cell stack, water condensation occurs easily in comparison with the other power generation cells at the center of the fuel cell stack, and the power generation performance is lowered because the water produced during power generation is not discharged from the fuel cell stack smoothly.

In this regard, for example, fuel cell stack structure as disclosed in Japanese Laid-Open Patent Publication No. 2003-338305 is known. In the stack structure, in FIG. 6, a cell is formed by stacking an MEA (membrane electrode assembly) and separators, and a plurality of the cells are stacked together to form a module 1.

A plurality of the modules 1 are stacked together to form a cell stack. At opposite ends of the cell stack, layers 2 where no power generation is performed are provided. For example, the layers 2 have gas flow fields, and include dummy cells that do not have any MEAs.

At the opposite ends of the cell stack including the layers 2, terminals 3, insulators 4, and end plates 5 are provided to form a fuel cell stack 6.

Pipes 7 are connected to the end plate 5 provided at one end of the fuel cell stack 6 in the stacking direction. Fluids such as water, the fuel gas, and the oxygen-containing gas are supplied and discharged to/from manifolds (not shown) through the pipes 7.

In the fuel cell stack 6, when operation is started after a long period of soaking time (when the fuel cell stack is not used for a long period of time) from the time when operation was stopped last time, in particular, the voltage of the module 1 on the end plate 5 side where the pipes 7 for supplying the fluids are provided is decreased. Therefore, the performance of starting operation of the fuel cell stack 6 is poor.

This is because, in the module 1 near the pipes 7, for example, the fuel gas and the oxygen-containing gas are not distributed smoothly, and the condensed water is not eliminated sufficiently at the layers 2 and then flows into the module 1. Further, the condensed water is retained in the fuel cell stack 6, and the surface pressure is not uniform.

### SUMMARY OF THE INVENTION

The present invention has been made to meet the demands of this type, and an object of the present invention is to provide a fuel cell stack having dummy cells to achieve the desired heat insulating capability, reliably prevent condensed water from flowing into power generation units, and achieve good power generation performance with a simple structure.

The present invention relates to a fuel cell stack including a stack body formed by stacking a plurality of power generation cells. Each of the power generation cells includes an electrolyte electrode assembly and a separator. The electrolyte electrode assembly includes a pair of electrodes and an electrolyte interposed between the pair of electrodes. Reactant gas flow fields are formed along electrode surfaces of the power generation cells. Reactant gas passages are connected to the reactant gas flow fields, and extend through the power generation cells in the stacking direction. Terminal plates, insulating plates, and end plates are provided at both ends of the stack body. Reactant gas pipes are connected to one of the end plates, and communicate with the reactant gas passages.

Dummy cells corresponding to the power generation cells are provided at both ends of the stack body in the stacking direction. Each of the dummy cells includes a dummy electrode assembly having an electrically conductive plate corresponding to the electrolyte, and dummy separators sandwiching the dummy electrode assembly. The dummy separators have a structure identical to the separator. The number of the dummy cells provided near one of the end plates is larger than the number of the dummy cells provided near the other of the end plates.

In the present invention, the number of the dummy cells near one of the end plates to which the reactant gas pipes are connected is larger than the number of the dummy cells near the other of the end plates. Therefore, the condensed water from the reactant gas pipes into the fuel cell stack can be collected reliably by the stack of the dummy cells. In the structure, it becomes possible to prevent entry of the condensed water into the power generation cell.

Further, since the plurality of dummy cells are stacked together, the desired heat insulating capability is achieved as a whole. Improvement in the heat mass is achieved, the condensed water is eliminated, and the surface pressure becomes uniform easily.

The above and other objects, features and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a perspective view schematically showing a fuel cell stack according to an embodiment of the present invention;

FIG. 2 is a cross sectional view showing main components of the fuel cell stack;

FIG. 3 is a perspective view schematically showing main components of a power generation unit of the fuel cell stack;

FIG. 4 is an exploded perspective view schematically showing a first dummy unit of the fuel cell stack;

FIG. 5 is a graph showing the relationship between the soaking time and the amount of retained water at both ends of the fuel cell stack; and

FIG. 6 is a view showing a stack structure of a fuel cell disclosed in Japanese Laid-Open Patent Publication No. 2003-338305.

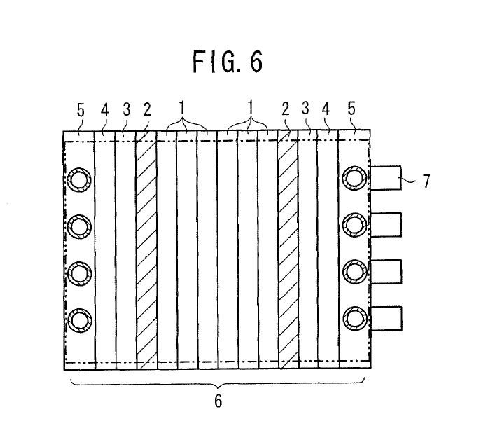

### DESCRIPTION OF THE PREFERRED EMBODIMENTS

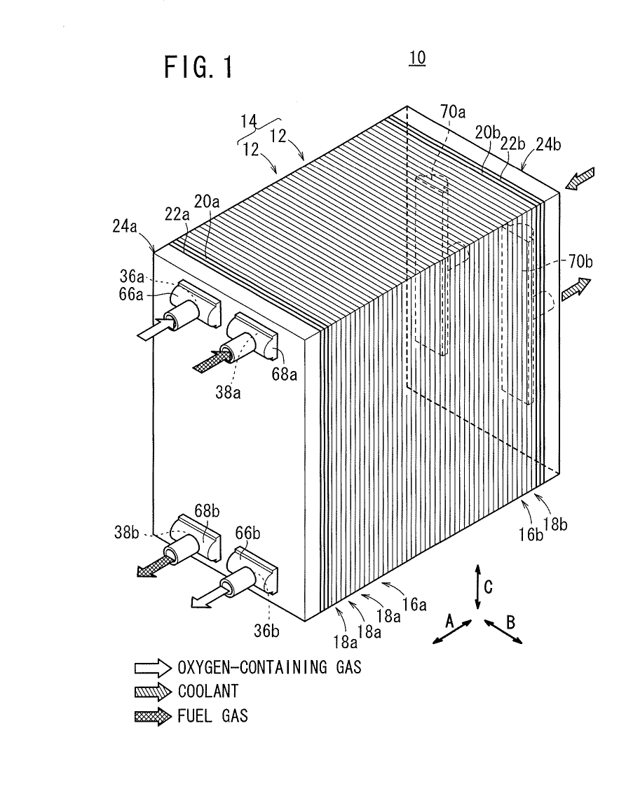

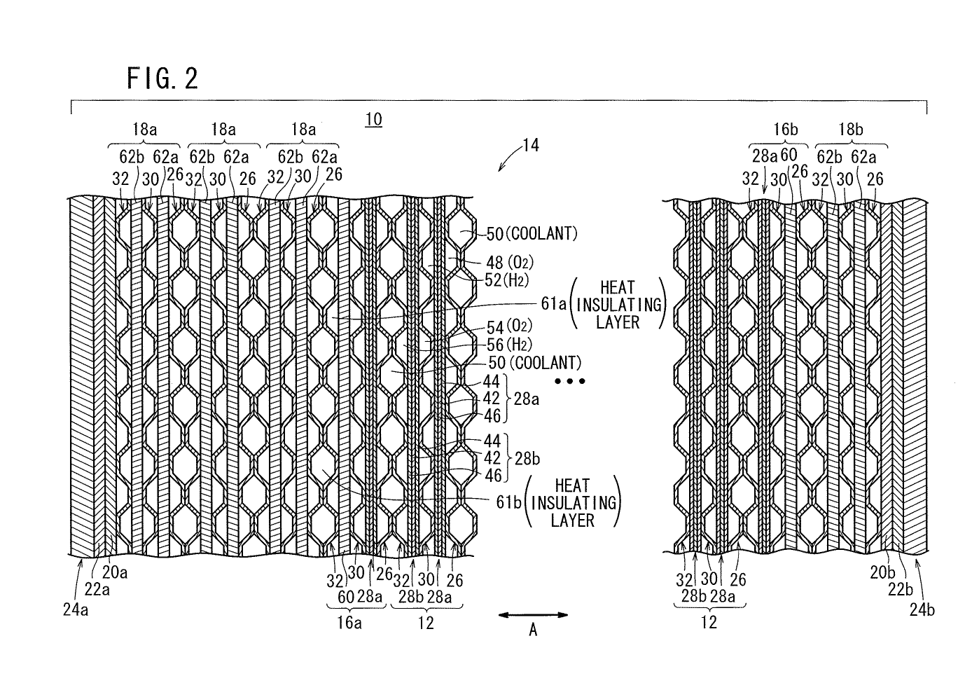

As shown in FIGS. 1 and 2, a fuel cell stack 10 according to an embodiment of the present invention includes a stack body 14 formed by stacking a plurality of power generation units (power generation cells) 12 in a stacking direction indicated by an arrow A. At one end of the stack body 14 in the stacking direction, a first end power generation unit 16a is provided, and a plurality of first dummy units (dummy cells) 18a are provided outside the first end power generation unit 16a. At the other end of the stack body 14 in the stacking direction, a second end power generation unit 16b is provided, and at least one second dummy unit (dummy cell) 18b is provided outside the second end power generation unit 16b. Terminal plates 20a, 20b are provided outside the first and second dummy units 18a, 18b. Insulating plates 22a, 22b are provided outside the terminal plates 20a, 20b. Further, end plates 24a, 24b are provided outside the insulating plates 22a, 22b.

For example, components of the fuel cell stack 10 are held together by a box-shaped casing (not shown) including the end plates 24a, 24b each having a rectangular shape. Alternatively, components of the fuel cell stack 10 are tightened together by a plurality of tie-rods (not shown) extending in the direction indicated by the arrow A.

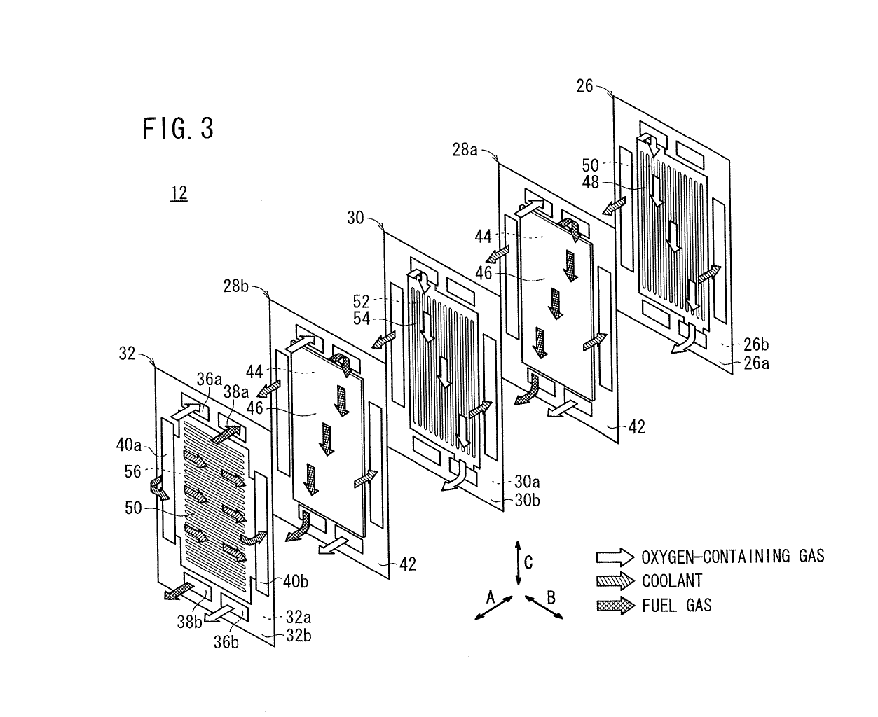

As shown in FIG. 3, the power generation unit 12 is formed by stacking a first membrane electrode assembly 28a on a first separator 26, a second separator 30 on the first membrane electrode assembly 28a, a second membrane electrode assembly 28b on the second separator 30, and a third separator 32 on the second membrane electrode assembly 28b in the direction indicated by the arrow A. Metal separators or carbon separators may be used as the first separator 26, the second separator 30, and the third separator 32. Though not shown, in the case where metal separators are used, seal members are formed integrally with the metal separators. In the case where carbon separators are used, separate seal members (e.g., packing members) are stacked on the carbon separators.

At an upper end of the power generation unit 12 in a longitudinal direction, an oxygen-containing gas supply passage (reactant gas passage) 36a for supplying an oxygen-containing gas and a fuel gas supply passage (reactant gas passage) 38a for supplying a fuel gas such as a hydrogen-containing gas are provided. The oxygen-containing gas supply passage 36a and the fuel gas supply passage 38a extend through the power generation unit 12 in the direction indicated by the arrow A.

At a lower end of the power generation unit 12 in the longitudinal direction, a fuel gas discharge passage (reactant gas passage) 38b for discharging the fuel gas and an oxygen-containing gas discharge passage (reactant gas passage) 36b for discharging the oxygen-containing gas are provided. The fuel gas discharge passage 38b and the oxygen-containing gas discharge passage 36b extend through the power generation unit 12 in the direction indicated by the arrow A.

At one end of the power generation unit 12 in a lateral direction indicated by an arrow B, a coolant supply passage 40a for supplying a coolant is provided, and at the other end of the power generation unit 12 in the lateral direction indicated by the arrow B, a coolant discharge passage 40b for discharging the coolant are provided. The coolant supply passage 40a and the coolant discharge passage 40b extend through the power generation unit 12 in the direction indicated by the arrow A.

Each of the first and second membrane electrode assemblies (electrolyte electrode assemblies) 28a, 28b includes a cathode 44, an anode 46, and a solid polymer electrolyte membrane (electrolyte) 42 interposed between the cathode 44 and the anode 46. The solid polymer electrolyte membrane 42 is formed by impregnating a thin membrane of perfluorosulfonic acid with water, for example.

Each of the cathode 44 and the anode 46 has a gas diffusion layer (not shown) such as a carbon paper, and an electrode catalyst layer (not shown) of platinum alloy supported on porous carbon particles. The carbon particles are deposited uniformly on the surface of the gas diffusion layer. The electrode catalyst layer of the cathode 44 and the electrode catalyst layer of the anode 46 are fixed to both surfaces of the solid polymer electrolyte membrane 42, respectively.

The first separator 26 has a first oxygen-containing gas flow field (reactant gas flow field) 48 on its surface 26a facing the first membrane electrode assembly 28a. The first oxygen-containing gas flow field 48 is connected to the oxygen-containing gas supply passage 36a and the oxygen-containing gas discharge passage 36b. The first oxygen-containing gas flow field 48 includes a plurality of flow grooves extending in the direction indicated by the arrow C. A coolant flow field 50 is formed on a surface 26b of the first separator 26. The coolant flow field 50 is connected to the coolant supply passage 40a and the coolant discharge passage 40b.

The second separator 30 has a first fuel gas flow field (reactant gas flow field) 52 on its surface 30a facing the first membrane electrode assembly 28a. The first fuel gas flow field 52 is connected to the fuel gas supply passage 38a and the fuel gas discharge passage 38b. The first fuel gas flow field 52 includes a plurality of flow grooves extending in the direction indicated by the arrow C.

The second separator 30 has a second oxygen-containing gas flow field (reactant gas flow field) 54 on its surface 30b facing the second membrane electrode assembly 28b. The second oxygen-containing gas flow field 54 is connected to the oxygen-containing gas supply passage 36a and the oxygen-containing gas discharge passage 36b.

The third separator 32 has a second fuel gas flow field (reactant gas flow field) 56 on its surface 32a facing the second membrane electrode assembly 28b. The second fuel gas flow field 56 is connected to the fuel gas supply passage 38a and the fuel gas discharge passage 38b. The third separator 32 has a coolant flow field 50 on a surface 32b of the third separator 32. The coolant flow field 50 is connected to the coolant supply passage 40a and the coolant discharge passage 40b.

As shown in FIG. 2, the first end power generation unit 16a includes the first separator 26 stacked on the power generation unit 12, the first membrane electrode assembly 28a stacked on the first separator 26, the second separator 30 stacked on the first membrane electrode assembly 28a, an electrically conductive plate (dummy electrolyte electrode assembly) 60 stacked on the second separator 30, and the third separator 32 stacked on the electrically conductive plate 60. In effect, the first end power generation unit 16a is a mixture unit of part of the power generation unit 12 and part of the first dummy unit 18a.

The first end power generation unit 16a has a heat insulating layer 61a formed by limiting the flow of the fuel gas, at a position corresponding to the second fuel gas flow field 56. Specifically, the second fuel gas flow field 56 is sealed from the fuel gas supply passage 38a and the fuel gas discharge passage 38b.

A heat insulating layer 61b is formed between the first end power generation unit 16a and the first dummy unit 18a, by limiting the flow of the coolant, at a position corresponding to the coolant flow field 50. Specifically, the coolant flow field 50 is sealed from the coolant supply passage 40a and the coolant discharge passage 40b.

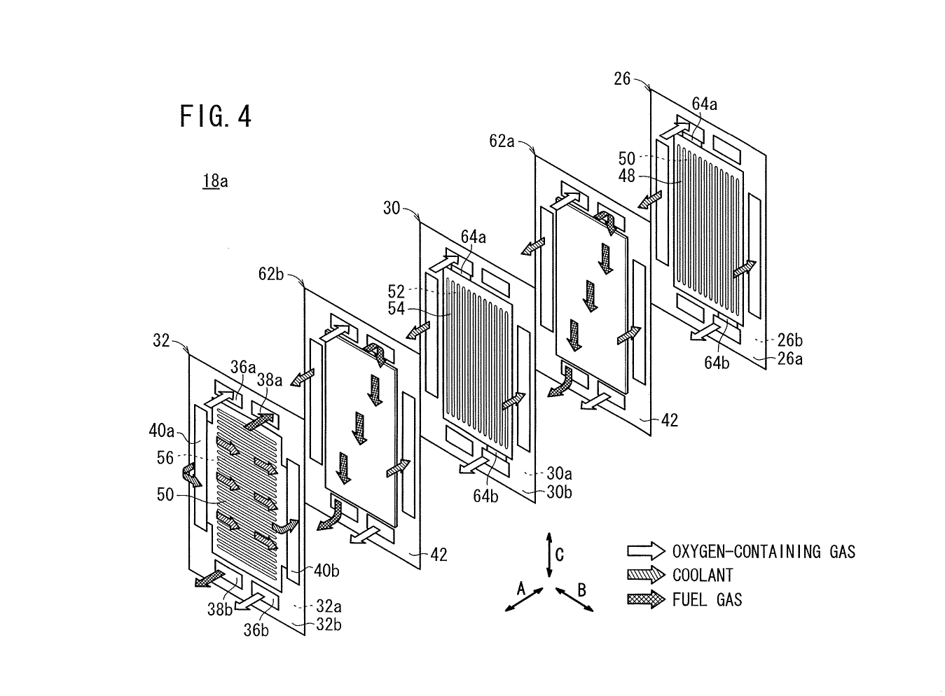

As shown in FIG. 4, the first dummy unit 18a includes the first separator 26 stacked on the first end power generation unit 16a, a first electrically conductive plate (first dummy electrolyte electrode assembly) 62a stacked on the first separator 26, the second separator 30 stacked on the first electrically conductive plate 62a, a second electrically conductive plate (second dummy electrolyte electrode assembly) 62b stacked on the second separator 30, and the third separator 32 stacked on the second electrically conductive plate 62b. For example, the electrically conductive plate 60, the first electrically conductive plate 62a and the second electrically conductive plate 62b have the thickness equal to the thickness of the first membrane electrode assembly 28a, and the electrically conductive plate 60, the first electrically conductive plate 62a and the second electrically conductive plate 62b do not have the power generation function.

In the first dummy unit 18a, in order to limit the flow of the oxygen-containing gas into the first oxygen-containing gas flow field 48 and the second oxygen-containing gas flow field 54, the first oxygen-containing gas flow field 48 is sealed from the oxygen-containing gas supply passage 36a and the oxygen-containing gas discharge passage 36b by interruption sections 64a, 64b, and the second oxygen-containing gas flow field 54 is sealed from the oxygen-containing gas supply passage 36a and the oxygen-containing gas discharge passage 36b by interruption sections 64a, 64b.

In the first dummy unit 18a, the fuel gas flows along the first fuel gas flow field 52 and the second fuel gas flow field 56, and the coolant flows along the coolant flow field 50.

The second end power generation unit 16b has the same structure as the first end power generation unit 16a, and the second dummy unit 18b has the same structure as the first dummy unit 18a.

The number of the first dummy units 18a is larger than the number of the second dummy units 18b. For example, the number of the first dummy units 18a is determined depending on the number of the stacked power generation units 12, or such that the stacked length of the first dummy units 18a is no less than 0.5% of the stacked length of the stack body 14. Alternatively, the number of the first dummy units 18a is three or more.

As shown in FIG. 1, at upper and lower opposite ends of the end plate 24a, an oxygen-containing gas inlet manifold (reactant gas pipe) 66a, a fuel gas inlet manifold (reactant gas pipe) 68a, an oxygen-containing gas outlet manifold (reactant gas pipe) 66b, and a fuel gas outlet manifold (reactant gas pipe) 68b are provided. The oxygen-containing gas inlet manifold 66a is connected to the oxygen-containing gas supply passage 36a, the fuel gas inlet manifold 68a is connected to the fuel gas supply passage 38a, the oxygen-containing gas outlet manifold 66b is connected to the oxygen-containing gas discharge passage 36b, and the fuel gas outlet manifold 68b is connected to the fuel gas discharge passage 38b.

Though not shown, the fuel gas supply apparatus and the oxygen-containing gas supply apparatus are connected to the end plate 24a. The fuel gas outlet manifold 68b is connected to the fuel gas inlet manifold 68a through a return channel (not shown) so that the fuel gas can be circulated, and used again. Thus, the hydrogen as the fuel gas is not discarded wastefully.

At left and right opposite ends of the end plate 24b, a coolant inlet manifold 70a and a coolant outlet manifold 70b are provided. The coolant inlet manifold 70a is connected to the coolant supply passage 40a, and the coolant outlet manifold 70b is connected to the coolant discharge passage 40b.

Operation of the fuel cell stack 10 will be described below.

Firstly, as shown in FIG. 1, in the fuel cell stack 10, at the end plate 24a, an oxygen-containing gas is supplied to the oxygen-containing gas inlet manifold 66a and a fuel gas such as a hydrogen-containing gas is supplied to the fuel gas inlet manifold 68a. Further, at the end plate 24b, a coolant such as pure water or ethylene glycol is supplied to the coolant inlet manifold 70a.

As shown in FIG. 3, the oxygen-containing gas flows from the oxygen-containing gas supply passage 36a of each power generation unit 12 into the first oxygen-containing gas flow field 48 of the first separator 26 and the second oxygen-containing gas flow field 54 of the second separator 30. Thus, the oxygen-containing gas flows downwardly along the respective cathodes 44 of the first and second membrane electrode assemblies 28a, 28b.

The fuel gas flows from the fuel gas supply passage 38a of each power generation unit 12 to the first fuel gas flow field 52 of the second separator 30 and the second fuel gas flow field 56 of the third separator 32. Thus, the fuel gas flows downwardly along the respective anodes 46 of the first and second membrane electrode assemblies 28a, 28b.

As described above, in each of the first and second membrane electrode assemblies 28a, 28b, the oxygen-containing gas supplied to the cathode 44 and the fuel gas supplied to the anode 46 are consumed in the electrochemical reactions at electrode catalyst layers of the cathode 44 and the anode 46 for generating electricity.

Then, the oxygen-containing gas after partially consumed at the cathode 44 is discharged from the oxygen-containing gas discharge passage 36b to the oxygen-containing gas outlet manifold 66b (see FIG. 1). Likewise, the fuel gas after partially consumed at the anode 46 is discharged from the fuel gas discharge passage 38b to the fuel gas outlet manifold 68b.

Further, as shown in FIGS. 2 and 3, the coolant flows into the coolant flow field 50 formed between the power generation units 12. The coolant flows in the horizontal direction indicated by the arrow B in FIG. 3, and cools the second membrane electrode assembly 28b of one of the adjacent power generation units 12, and cools the first membrane electrode assembly 28a of the other of the adjacent power generation units 12. That is, the coolant does not cool the space between the first and second membrane electrode assemblies 28a, 28b inside the power generation unit 12, for performing skip cooling. Thereafter, the coolant is discharged from the coolant discharge passage 40b into the coolant outlet manifold 70b.

In the embodiment of the present invention, the first dummy units 18a are provided on the end plate 24a side where the oxygen-containing gas inlet manifold 66a, the fuel gas inlet manifold 68a, the oxygen-containing gas outlet manifold 66b, and the fuel gas outlet manifold 68b are provided as reactant gas pipes, and the second dummy units 18b are provided on the end plate 24b side. The number of the first dummy units 18a is larger than the number of the second dummy units 18b.

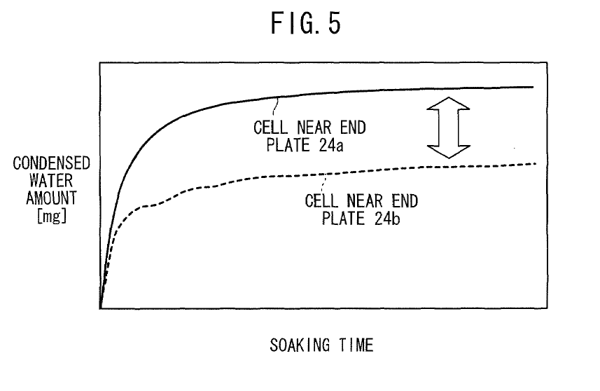

A fuel cell stack that does not use the first and second end power generation units 16a, 16b or the first and second dummy units 18a, 18b was prepared, and for each of the power generation units 12 adjacent to the end plates 24a, 24b, the relationship between the soaking time and the amount of retained water (amount of condensed water) after operation has been stopped is calculated as shown in FIG. 5.

That is, when, for example, 30 minutes has elapsed after the start of soaking, water condensation occurs to a large extent due to sharp decrease in the gas temperature. At this time, since the temperature gradient on the end plate 24a side (reactant gas pipe side) is large, the amount of water retained in the power generation unit 12 adjacent to the end plate 24a is considerably larger than the amount of water retained in the power generation unit 12 adjacent to the end plate 24b.

In this regard, in the embodiment of the present invention, the number of the first dummy units 18a at the end plate 24a side, where large amount of retained water is easily generated, is larger than the number of the second dummy units 18b. Therefore, the condensed water from the reactant gas pipes, in particular, from the fuel gas inlet manifold 68a to the fuel gas supply passage 38a can be collected reliably by the stack of the first dummy units 18a.

In the structure, it becomes possible to prevent entry of the condensed water into the power generation unit 12. With the simple structure, the desired power generation performance is achieved.

Further, since the plurality of first dummy units 18a are stacked together, the desired heat insulating capability is achieved as a whole. Improvement in the heat mass is achieved, the condensed water is removed, and the surface pressure becomes uniform easily.

Further, in the embodiment of the present invention, the heat insulating layer 61b corresponding to the coolant flow field 50 is formed between the first end power generation unit 16a adjacent to the power generation unit 12 and the first dummy unit 18a. In the structure, in particular, improvement in the performance of starting operation of the fuel cell stack 10 at low temperature is achieved without inhibiting the raise in temperature of the power generation unit 12.

In the first dummy unit 18a and the second dummy unit 18b, since the coolant flows in each coolant flow field 50, after operation of the fuel cell stack 10 is stopped, in the presence of the coolant having relatively high temperature, the heat is retained advantageously, and it becomes possible to effectively decrease the amount of the condensed water in the fuel cell stack 10.

Further, in each of the first dummy unit 18a and the second dummy unit 18b, the fuel gas is supplied to the first fuel gas flow field 52 and the second fuel gas flow field 56, and the coolant is supplied to each coolant flow field 50. The flow of the oxygen-containing gas to the first oxygen-containing gas flow field 48 and the second oxygen-containing gas flow field 54 is limited. The fuel gas flows through the return channel (not shown), and is used again. Therefore, the fuel gas is not discharged wastefully. In the meanwhile, the oxygen-containing gas is discharged to the outside.

In the operation after soaking, problems associated with the oxygen-containing gas do not occur easily. However, problems tend to occur due to factors such as distribution of the fuel gas, water condensation, and supply of water. Therefore, by limiting the flow of the oxygen-containing gas, the oxygen-containing gas can be prevented from being consumed wastefully.

The number of the first dummy units 18a is determined depending on the number of the power generation units 12, or such that the stacked length of the first dummy units 18a is not less than 0.5% of the stacked length of the stack body 14. Alternatively, the number of the first dummy units 18a is three or more.

In the case where the number of the stacked power generation units 12 is large, the amount of the gas at the inlet of the fuel gas supply passage 38a is large, and the gas flow rate is high. Under the circumstances, since the gas is not diffused easily, the reactant gas (in particular, fuel gas) may not smoothly enter the power generation units 12 on the end plate 24a side where the reactant gas pipes are provided. Therefore, by increasing the number of the first dummy units 18a depending on the number of the stacked power generation units 12, it becomes possible to smoothly and reliably supply the reactant gas to the power generation units 12.

In the embodiment of the present invention, the fuel cell stack 10 includes the power generation units 12 having so called skip cooling structure where the coolant flow field 50 is provided at intervals of a plurality of unit cells. However, the present invention is not limited in this respect. For example, the present invention is applicable to the power generation unit where the coolant flow field 50 is provided for each of the unit cells.

While the invention has been particularly shown and described with reference to the preferred embodiment, it will be understood that variations and modifications can be effected thereto by those skilled in the art without departing from the scope of the invention as defined by the appended claims.

What is claimed is:

1. A fuel cell stack including a stack body formed by stacking a plurality of power generation cells, the power generation cells each comprising an electrolyte electrode assembly and a separator, the electrolyte electrode assembly including a pair of electrodes and an electrolyte interposed between the pair of electrodes, reactant gas flow fields being formed along electrode surfaces of the power generation cells, reactant gas passages being connected to the reactant gas flow fields and extending through the power generation cells in a stacking direction, terminal plates, insulating plates, and end plates being provided at both ends of the stack body, reactant gas pipes being connected to one of the end plates, the reactant gas pipes communicating with the reactant gas passages,
wherein dummy cells corresponding to the power generation cells are provided at both ends of the stack body in the stacking direction,
the dummy cells each including a dummy electrode assembly having an electrically conductive plate corresponding to the electrolyte, and dummy separators sandwiching the dummy electrode assembly, the dummy separators having a structure identical to the separator; and
the number of the dummy cells provided near one of the end plates is larger than the number of the dummy cells provided near the other of the end plates.

2. A fuel cell stack according to claim 1, wherein in the dummy cells provided near the one of the end plates, the flow of a coolant between the stack body and the dummy cell adjacent to the stack body is limited, and the coolant flows between the other dummy cells.

3. A fuel cell stack according to claim 1, wherein, in the dummy cells, the flow of the oxygen-containing gas to one of the reactant gas flow fields is limited, and the fuel gas is supplied to the other of the reactant gas flow fields.

4. A fuel cell stack according to claim 1, wherein the reactant gas pipes connected to the one of the end plates at least include a fuel gas supply pipe.

5. A fuel cell stack according to claim 1, wherein the power generation cell is formed by stacking a first electrolyte electrode assembly on a first separator, a second separator on the first electrolyte electrode assembly, a second electrolyte electrode assembly on the second separator, and a third separator on the second electrolyte electrode assembly;
the reactant gas flow field for supplying a predetermined reactant gas along a power generation surface is formed in each of spaces between the first separator and the first electrolyte electrode assembly, between the first electrolyte electrode assembly and the second separator, between the second separator and the second electrolyte electrode assembly, and between the second electrolyte electrode assembly and the third separator; and
a coolant flow field for supplying a coolant is formed in each of spaces between the power generation cells.

6. A fuel cell stack according to claim 5, wherein an end power generation cell is provided between the stack body and the dummy cell, and the end power generation cell is formed by stacking the first separator on the power generation cell, the first electrolyte electrode assembly on the first separator, the second separator on the first electrolyte electrode assembly, an electrically conductive plate on the second separator, and a third separator on the electrically conductive plate.
